(19) United States
(12) Patent Application Publication
(10) Pub. No.: US 2011/0140545 A1
(43) Pub. Date: Jun. 16, 2011

(54) Remote Activation System

(76) Inventor: John Joseph Eikum, Circle Pines, MN (US)

(21) Appl. No.: 13/035,863

(22) Filed: Feb. 25, 2011

Related U.S. Application Data
(63) Continuation-in-part of application No. PCT/US2009/055021, filed on Aug. 26, 2009.
(60) Provisional application No. 61/093,095, filed on Aug. 29, 2008.

(51) Int. Cl. H01H 47/24

(52) U.S. Cl. 307/117

(57) ABSTRACT

A remote activation system is disclosed that consumes no standby power. The system comprises a remote electromagnetic radiation transmitter able to transmit radiation having sufficient power to enable the closure of a switch. The system also comprises an electrical activation element that is electrically attached to both the on-off circuit of an electrically powered device and a source of power to permit normal operation of the device. The activation element comprises a first electromagnetic radiation power converter able to convert electromagnetic radiation power into electrical power. It also comprises a first electrically operated normally non-conducting switch that is between a source of power for the device and its on-off circuit. The remotely activated device does not draw any power when it is turned off except for optional functions such as clocks that are not related to activation.

### CROSS REFERENCE TO RELATED APPLICATIONS

This continuation-in-part application claims the benefit of PPA Appl. No. 61/093,095 filed Aug. 29, 2008 by John J. Eikum and PCT/US09/55021 filed Aug. 26, 2009 by John J. Eikum.

### FIELD OF THE INVENTION

This invention relates to wasted electrical power conservation and, particularly, to the elimination of wasted electrical power consumption in remote activation systems for electrically powered devices.

### BACKGROUND OF THE INVENTION

In recent years two trends, convenience and global warming, have come together to create an increase in wasted electrical power consumption and a demand to reduce that wasted power. Advances in electronics have resulted in a greater convenience through increased ability to perform tasks with remote control devices that would traditionally require more physical movement even from those who are disabled. Global warming concerns have attracted public and government attention, prompting increased interest in reducing wasted electrical power consumption where possible.

Electrically powered devices that respond to remote control transmitters generally consume standby power when the devices are off. Standby power is power consumed by an electrically powered device when the device is not in use but is still consuming power from a source of power. Standby power is often considered wasted power. In operation, a remote control transmitter supplies a signal to an energized on-off circuit in these devices to cause them to switch from a standby mode to a normal operation mode. The device also draws power to enable the on-off circuit to act upon a remote signal to enable it to shift to a normal operation mode. This power consumption generally is between one and ten Watts per device. However, when the power consumption is aggregated among the many remotely controlled electrical devices in use in a region or country, the amount of power consumed becomes significant.

The standby power consumption of remotely controlled devices has not been eliminated. Efforts to reduce this wasted power have not been completely successful. Some systems now consume less than a watt instead of several watts but still consume some power. Recent patents teach the use of monitoring circuits with or without rechargeable batteries but these also consume power. Others teach that the device turns itself off, requiring a manual effort to turn the device back on and the user may have to walk over to the device to manually reset the power-saving feature before a remote control device is able to interact with the electrically powered device.

There is still a need for a remote activation system that completely eliminates to the need for this standby power consumption while it maintains the convenience of being able to remotely power-on devices.

### SUMMARY OF THE INVENTION

I have invented a remote activation system for electrically powered devices that uses remotely transmitted electromagnetic radiation power to completely energize on-off circuitry in remotely activated devices with no standby power consumed to maintain remote activation capability. As a result, the electrically powered device is still readily activated by a remote means but does not consume any power to enable it to be remotely activated. The system comprises a remote electromagnetic radiation transmitter able to transmit radiation having sufficient power to enable the change in state of an electrical switch. The system also comprises an electrical activation element that is electrically attached to both the on-off circuit of an electrically powered device and a source of power to permit normal operation of the device. The activation element comprises a first electromagnetic radiation power converter able to convert electromagnetic radiation power into electrical power. It also comprises a first electrically operated normally non-conducting switch that is between a source of power for the device and its on-off circuit. The switch is electrically connected with the converter and has a non-conducting state where the on-off circuit is not able to draw any power and a conducting state where the on-off circuit is able to draw sufficient power for normal operation of the device. The electrically powered device does not draw any power from any source to maintain its ability to be remotely turned on either to power the converter until it receives a remote transmission or to monitor the status of the converter. In addition, the switch has a non-conducting state when the electrically powered device is turned off.

The invention offers substantial savings in greenhouse gases created by burning coal and natural gas to create electricity because of the savings achieved in eliminating electrical power consumption. In 2008, 51% of electricity created in the US was from the burning of coal. The combustion of natural gas produced 17%. However, these processes also create a high level of carbon dioxide, a known greenhouse gas responsible for global warming.

Remotely activated devices are desired but represent a source of significant wasted power. They offer a convenience that has made them popular among consumers. Devices such as, for example, televisions, video cassette players and recorders and digital video players and recorders are only some of the remote controlled devices that are particularly popular. However, present remote controlled devices consume significant wasted power by remaining in a standby mode when not in use.

My invention provides potentially significant power savings if used widely. While the standby power consumed per device is relatively small, generally between one and ten Watts, the amount of power consumed in a region or a country can be on the order of many millions of watts. Because my activation system has the remote control transmitter providing all of the power to activate the device, no power is consumed in a standby mode by an energized on-off circuit or by other techniques such as monitoring circuit requirements. Consumers need not lose the convenience of remote activation of their devices while reducing power consumption.

### BRIEF DESCRIPTION OF THE DRAWINGS

Embodiments of the invention are described in the accompanying figures. The figures are briefly described below.

FIG. 1 is a block diagram of one embodiment of the invention.

FIG. 2 is an illustration of an embodiment of the invention used with a digital video player device.

FIG. 3 is a block diagram of an embodiment of the invention able to stay on after radiation power exposure is terminated.

FIG. 4 is a block diagram of an embodiment of the invention that uses less gate current to turn on a device than that shown in FIG. 3.

FIG. 5 is a block diagram of an embodiment of the invention that uses less gate current to turn on a device than that shown in FIG. 4.

FIG. 6 is a block diagram of an embodiment of the invention that also has a power off function.

FIG. 7 is a block diagram of an embodiment of the invention that activates a two-way device.

### DETAILED DESCRIPTION OF SOME EMBODIMENTS OF THE INVENTION

Concerns about global warming have thrust energy efficiency to the forefront of public opinion. Standby power is that power consumed when electrically-devices are not used or are disconnected. The wasted standby power of individual household and office electrically powered devices is typically very small, but the sum of all such electrically-powered devices within these places becomes significant. Standby power makes up a portion of homes' and offices' steadily rising miscellaneous electric load, which also includes small electrically powered devices, security systems, and other small power draws.

The impact is great. For any single electrically powered device, the load is typically not very large. The most inefficient designs draw 15-20 Watts while many are on the order of one Watt. However when factored over all of the electrically powered devices in a country like the United States, the load can come to over many billions watts. Some studies have suggested the total standby load caused by the United States alone would provide enough power to handle the electric needs of Vietnam, Peru and Greece.

A significant amount of standby power consumption is truly wasted. Some of the standby power consumed by electrically powered devices is used to maintain useful functions. These functions include, for example, clocks to permit timed operations or delayed-time control operation, and circuits to permit continuous reception of information like faxes, virus protection packets, and emails in communication devices. Other standby power is used to maintain functions often considered needless when devices are plugged into sources of power but are not used. These functions include, for example, circuits that perform “instant on” functions for remote control access or monitoring functions to adjust current draw during times of waiting or normal remote use.

Generally, remote-controlled electrically powered devices require the use of some form of continual power consumption or stored power element to allow the device to be remotely controlled. When the devices are turned off, the on-off switching circuitry goes into an energized standby mode. In some devices, enough power is consumed to switch the on-off circuit to an “on” function with the reception of a signal from a remote device indicating such a change is desired. In others, power stored in such element as, for example, an energy buffer like gold capacitors or accumulators or batteries, is accessed to turn the device on by a signal from a remote device indicating such access is desired. This signal is generally of lower power and to frequently conveyed by a broadcast infrared means. Before my invention, the resulting standby power consumption on a continual basis or from a stored form was considered necessary to achieve the desired convenience for the user. My invention allows the user to retain the remote activation convenience while eliminating a source of wasted power that in aggregate amounts to a significant power consumption savings.

The following discussion is presented to enable a person of ordinary skill in the art to make and use the present teachings. Various modifications to the teachings and illustrated embodiments will be readily apparent to them, and the generic principles herein may be applied to other embodiments and applications without departing from the disclosed teachings. Thus, the present teachings are not intended to be limited to embodiments shown or discussed, but are to be accorded the widest scope consistent with the principles and features disclosed herein. The following detailed description is to be read with reference to the figures where like elements in different figures have like reference numbers. Those of ordinary skill in the art will recognize the examples provided herein have many useful alternatives that fall within the scope of the present teachings.

Embodiments of the present invention disclose converting sufficient electromagnetic radiation power to an electrical current to energize a circuit that powers on an electrically powered device so it can be used. Other embodiments disclose a method for turning an electrically powered device completely off to a state in which it draws no power and turning the device on again from a remote location without the use of wires to connect to the device from the remote location. Still other embodiments teach use of my system to activate two-way motors and other multiple-action devices.

My invention retains the ability of the device to be remotely activated while completely eliminating the wasted power consumption that is currently required. Instead of only supplying a signal to the energized signal-detection circuit of the on-off circuit of a device, I supply sufficient power to an unenergized powered off circuit to turn it on.

The system of my invention comprises a transmitter and an activation element electrically attached to a source of power and an electrical device. The transmitter is a remote electromagnetic radiation transmitter able to transmit radiation of sufficient power to enable the change in state of an electrical switch. Radiation may come from to such sources as, for example, a high intensity infrared beam, a visible light beam, a radio beam, and a collimated light beam from a laser. Some embodiments may use a high intensity infrared beam. Some embodiments may use a visible light beam. Some embodiments may use a radio beam. Some embodiments may use a collimated light beam from a laser. All of these sources are readily available. The only requirements are that the intensity transmitted to a receiver be high enough to prevent unintentional activation of the device from ambient radiation and be low enough not to cause safety concerns in the use contemplated.

Variations are possible in the transmitter assembly depend on design considerations. The amount of power needed to change the state of the switch depends on the components used in the activation element and the requirements of the electrically powered device. One or more traditional infrared transmitters to control other functions of the device once it is turned on may be used. In addition, the transmitter generating the activation radiation can be included in the same remote control container housing the infrared communication device and they both can be operated from the same battery.

The system also comprises an electrical activation element that is electrically attached to both the on-off circuit of an electrically powered device and a source of power to permit normal operation of the device when the device is activated. The activation element comprises a first electromagnetic radiation power converter able to convert electromagnetic radiation power into electrical power. It also comprises at least one electrically operated normally non-conducting switch that is between a source of power for the device and its on-off circuit. The switch is electrically connected with the converter and has a non-conducting state such that the on-off circuit is not able to draw any power and a conducting state such that the on-off circuit is able to draw sufficient power for normal operation of the device. The electrically powered device does not draw any power from any source to maintain its ability to be turned on remotely, either to power the converter until it receives a remote transmission or to monitor the status of the converter. In addition, the switch has a non-conducting state when the electrically powered device is turned off.

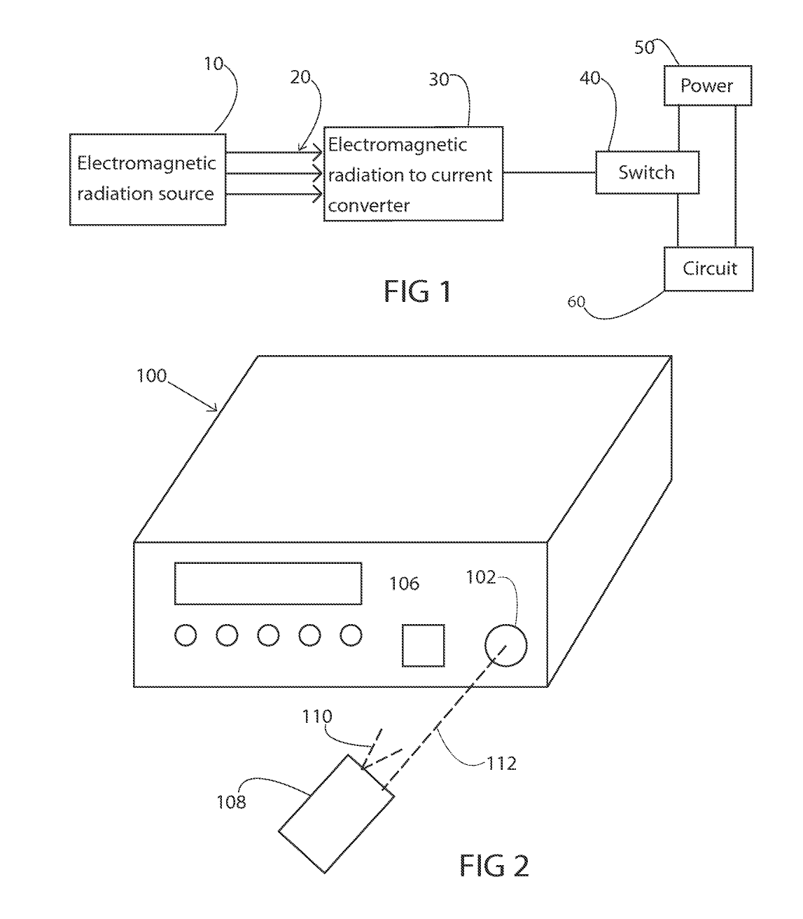

Various embodiments of the invention will be illustrated in the following figures. One embodiment of the remote activation system of the invention is illustrated in FIG. 1 as a block diagram. A remote transmitter (10) is positioned to convey electromagnetic radiation power (20) to an activation element that comprises an electromagnetic radiation to current converter (30) and a normally non-conductive switch (40). The current from converter 30 is sufficient to change normally non-conductive switch 40 into a conductive state. This change completes the circuit between a source of power (50) for an electrically powered device (not shown) and a power “on” circuit (60) that is electrically attached to the device to turn it on for normal operation.

As previously stated, the electromagnetic radiation can be of any type able to convey sufficient power to change the state of the switch. Several aspects affect this choice. One aspect is the distance between the remote and the converter. Generally electromagnetic radiation power affecting a specified area decreases with the distance between the transmitter and the receiver. The distance is enough to retain convenience of a remote but not enough to make passing the transmitted power to the receptor too challenging. Typically, the distance useful for the remote activation system is at least one meter and sometimes more than five meters.

A second aspect is the area of the receiving electromagnetic radiation receptor. Typically, these range from less than one square centimeter to more than several square centimeters. Funneling devices may be used to concentrate the radiation from a larger area to a smaller one.

A third aspect is the sensitivity of the switches. For example, triacs as a class are typically less sensitive that silicone controlled rectifiers. Each has sensitive gate versions that require even less power to change states. In addition, there is wide variation in sensitivity within each category and overlap can occur.

A fourth aspect is whether the radiation must be affecting the receptor as long as the device is on or only to initiate the “on” state. Absence or presence of at least one gate element is one way to achieve this. Suitable means exist to keep gates open and include, for example, latch circuits or relays electrically attached to newly opened lines of power sources.

A fifth aspect is visibility. Some embodiments are more useful if a user can see the striking of the transmitted radiation upon the receiver. One such source of visible radiation, as an example, is a red laser such as, for example, those used by laser pointers during presentations.

A sixth aspect is context. Applications in residential areas typically have significant safety concerns that require remote services not to use electromagnetic radiation of types and levels that may cause injury to people or objects. In contrast, to applications in some industrial areas may have significantly less concerns for safety.

They may be more concerned for performance and access to difficult to reach equipment where remote control access is beneficial.

An example to illustrate a residential embodiment of the invention is as follows. A red laser pointer was used with a wavelength of 650 nanometers and a maximum output of less than 5 milliwatts to affect a photo diode. The visible electromagnetic radiation was converted to electrical current and sent to a silicone-controlled rectifier (SCR). The current was sufficient to change the state of the SCR from a non-conductive state to a conductive state. This permitted a source of current from a 120 volt, alternating current wall socket to pass to an on-off circuit to turn it on. The current from the wall socket also passes through a standard relay. The relay was electrically attached to the SRC and acted in the same capacity as a latch circuit to keep the switch conductive even after the radiation from the laser was no longer contacting the photodiode so that the on-off circuit remained on. Many other combinations of components are possible to achieve remote activation of an on-off circuit of a device, once specific requirements of the system are known.

FIG. 2 is an illustration of one such device, a digital video diskette player. The device (100) has an optional mirrored funnel (102) leading to an electromagnetic radiation to current converter (not shown) to turn on the device. Funnel is optional and makes the target that is impacted by the radiation larger. It also has an infrared receiver (106) for receiving commands once the device is powered “on”. A remote control (108) provides an encoded infrared signal (110) for standard device operation and a laser beam light source (112) for powering on device 100.

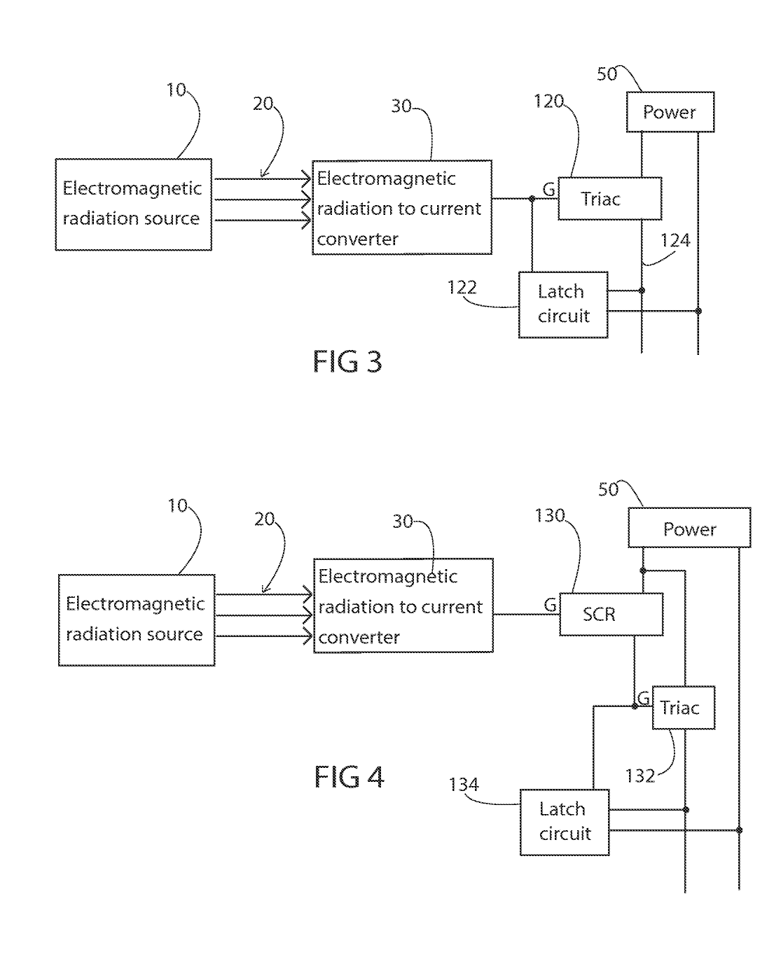

Several embodiments are shown in block diagrams in FIGS. 3, 4 and 5 that illustrate some design variations of embodiments with different sensitivities to radiation that are able to remain on after the transmitted radiation no longer contacts the converter. In the embodiment shown in the block diagram of FIG. 3, electromagnetic radiation source 10 transmits radiation 20 to electromagnetic radiation to current converter 30. Current is then passed to a switch composed of a triac (120) and a latch circuit (122). Once the triac is made conductive, power from source of power 50 is able to flow through a current path (124) to the device (not shown) as well as through latch circuit 122 to the gate to keep triac 120 conductive even if radiation 20 stops flowing. A latch circuit was used here but other components such as a relay used in the example above also are suitable as long as to they permit the triac to remain conductive with source current. After the device is powered on, the standard infrared signal and circuitry in the receiving device can be used to power off the device.

In the embodiment shown in the block diagram of FIG. 4, electromagnetic radiation source 10 transmits radiation 20 to electromagnetic radiation to current converter 30. Current is then passed to a switch composed of an SCR (130), a triac 132 and a latch circuit 134. The SRC is used to trigger the triac since SCRs typically require less power to change states. Alternating current power then flows both through triac 132 to completely open the current path from power 50 to the on-off circuit of the device (not shown) and into latch circuit 134 to keep the current path open even after radiation into the converter 30 is terminated.

In the embodiment shown in the block diagram of FIG. 5, electromagnetic radiation source 10 transmits radiation 20 to electromagnetic radiation to current converter 30. Current is then passed to a switch composed of a first SCR (140), a second SCR (142) and a latch circuit (144). SRC 140 is configured to pass alternating current with a positive voltage and SCR 142 is configured to pass alternating current with a negative voltage. Latching circuit 144 is electrically attached to both SCRs to permit passing of alternating current from source 50 to the device when the SRCs become conductive. Two SCRs generally require less gate current than one triac.

The electrically powered devices suitable for my invention are any that are desired to be operated by remote control devices. These include devices that are commonly turned on remotely such as, for example, a digital video diskette players, digital video recorders, video cassette players, videocassette recorders, sound systems, televisions, and video game apparatus, and lighting fixtures.

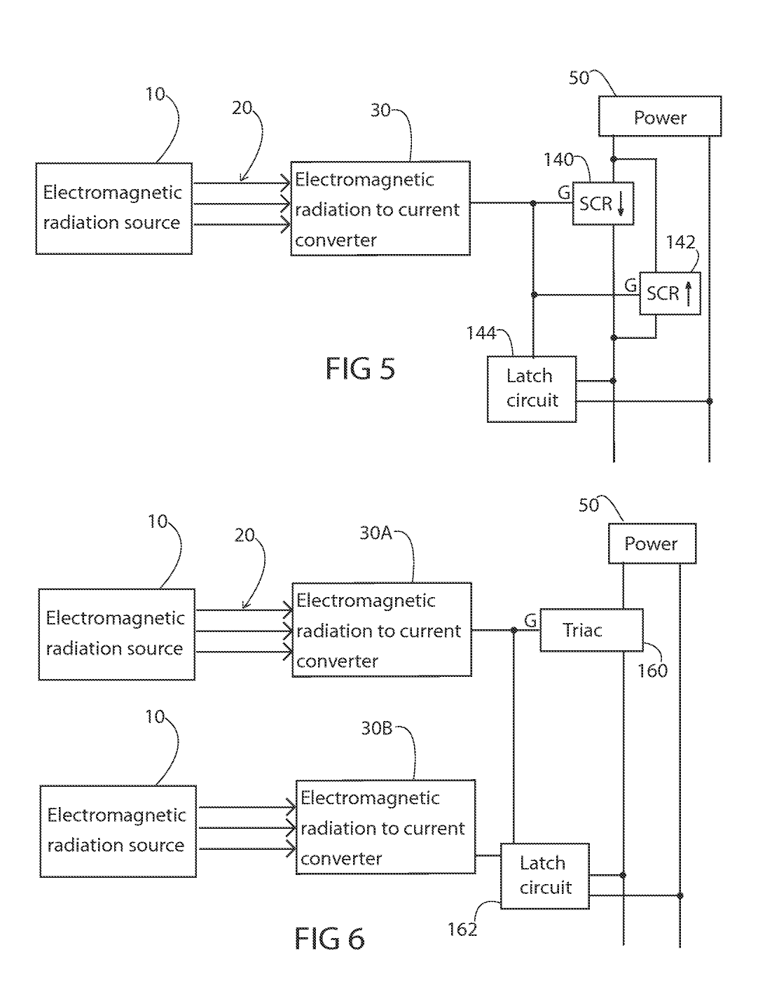

The electrically powered devices suitable for my invention also include devices that have both a remote activation capability and a remote deactivation capability for devices similar to those listed above. The embodiment shown in the block diagram of FIG. 6 illustrates such an activation system. An electromagnetic radiation source 10 transmits radiation 20 to a first electromagnetic radiation to current converter 30A. Current is then passed to a switch composed of a triac 160 and a latch circuit (162). Once the triac is made conductive, power from source of power 50 is able to flow through a current path to the on-off circuit of the device (not shown) as well as through latch circuit 162 to the gate to keep triac 160 conductive even if radiation 20 stops flowing. Latch circuit 162 has the ability to change the switch to a non-conductive state when radiation is transmitted to a second electromagnetic radiation to current converter 30B, and then to the latch circuit. The device is thus turned off.

The electrically powered devices suitable for my invention further include devices that have at least two actions that are remotely initiated by the activation system. These include devices such as, for example, a projector screen that is raised or lowered; a door that is raised or lowered; heating apparatus where heat is increased or decreased; a light that is dimmed or brightened; blinds, shades, and awnings that are opened or closed; a ceiling fan that is turned on or off, and set to summer or winter rotation; a window that is opened or closed. Limiting switches and latch circuits well known to the art could be used to terminate the action when it was completed without constant exposure to the transmitted radiation to the converter.

Alternatively, the action may require constant exposure of the transmitted radiation to the converter to keep the action going. In this case, the action is stopped when the transmitted radiation no longer contacts the converter.

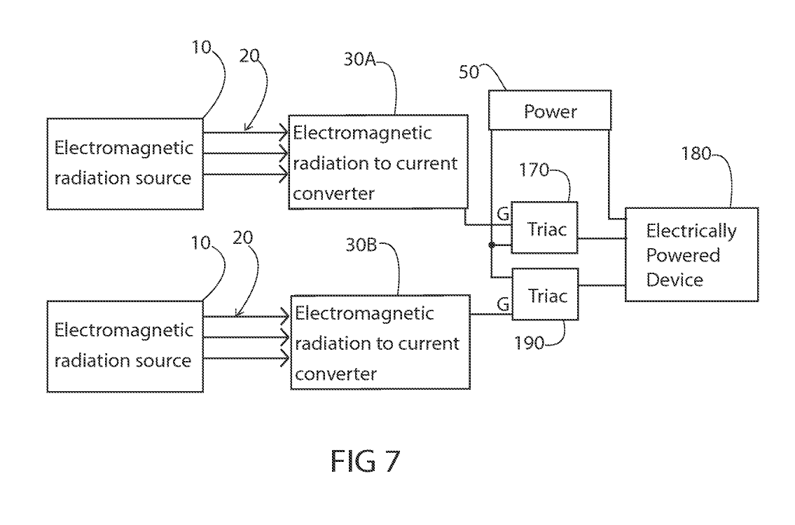

The embodiment shown in the block diagram of FIG. 7 illustrates such an activation system that requires constant exposure for a period of time. An electromagnetic radiation source 10 transmits radiation 20 to a first electromagnetic radiation to current converter 30A. Current is then passed to a first switch composed of a first triac (170) that is electrically attached to a source of power 50 and first action of an electrically powered device (180), such as, for example, a two-way motor, to activate the first action when the triac becomes conductive. The action continues as long as radiation 20 is being transmitted to converter 30A. In a separate action, an electromagnetic radiation source 10 transmits radiation 20 to a second electromagnetic radiation to current converter 30B. Current is then passed to a second switch composed of a second triac 190 that is electrically attached to a second action of electrically powered device 180 to activate the second action. The action continues as long as radiation 20 is being transmitted to converter 30B. No power is consumed while the remote activation system is not being operated. This embodiment provides a system that allows one to remotely turn on an electrically powered device that is not drawing any current until activated by radiation transmission from embodiment.

All components mentioned above are presently available and well known to the art.

Alternative designs may also be assembled with components well known to the art to permit an action to continue to a point until termination is desired without requiring continual exposure to the transmitted radiation. One such means would be to use a companion infrared transmission to convey detailed commands once the action is initiated by the electromagnetic radiation transmission of the invention. Other designs will be apparent to one of ordinary skill in the art.

In cases where the electrically powered device is operated with direct current and the source of power for the device is alternating current, well-known components may be used to convert current from alternating to direct once the device is activated. One such system is a bridge rectifier. It is recommended that circuits be designed so that power is completely removed from power-conversion transformers when the device is turned off to avoid power losses inherent in such transformers.

Other modifications and changes made to fit particular operating requirements and environments will be apparent to those with ordinary skill in the art. The present teachings can be practiced with well known components other than those disclosed. Thus, the invention is not considered limited to the embodiments discussed for purposes of disclosure and covers all changes and modifications that do not constitute departures from the true spirit and scope of this invention.

I claim:

1. A remote activation system for an electrically powered device, comprising,
a remote electromagnetic radiation transmitter able to transmit radiation having sufficient power to enable the change in state of an electrical switch and
an electrical activation element electrically attached to the on-off circuit of an electrically powered device and a source of power to permit normal operation of the device, comprising,
a first electromagnetic radiation power converter able to convert to electromagnetic radiation power into electrical power, and
a first electrically operated normally non-conducting switch that is between a source of power for the device and its on-off circuit, is electrically connected with the converter, and has a non-conducting state such that the on-off circuit is not able to draw any power and a conducting state such that the on-off circuit is able to draw sufficient power for normal operation of the device,
wherein the electrically powered device does not draw any power from any source to maintain its ability to be turned on remotely, either to power the converter until it receives a remote transmission, to open access to an external power transmission source, or to monitor the status of the converter, and
wherein the switch has a non-conducting state when the electrically powered device is turned off.

2. The remote activation system of claim 1 wherein the remote transmitter is a remote control device and the transmitter is able to transmit sufficient electromagnetic power to enable the closure of a switch that is at least one meter distant.

3. The remote activation system of claim 1 wherein the remote device further comprises an infrared radiation transmitter able to transmit sufficient radiation to enable the operation of additional functions of the on-off circuit of the electrically powered device from a distance of more than one meter once it is powered on.

4. The remote activation system of claim 1 wherein the electromagnetic radiation is visible.

5. The remote activation system of claim 1 wherein the electrical device is a remotely activated device such as a digital video player, digital video recorder, video cassette player, video cassette recorder, sound system, television, and video game apparatus, and lighting fixture.

6. The remote activation system of claim 1 wherein the switch comprises a triac element that when in a conductive state permits alternating current to flow from the source of power for the device into the device.

7. The remote activation system of claim 1 wherein the switch, further comprises,
a triac element to permit alternating current to flow into the device and
a latch circuit electrically attached to power connectors entering the device and a connector between the switch and the radiation power converter to keep the power passing from the source of power for the device to the device until a power off signal is transmitted to the device.

8. The remote activation system of claim 7 wherein the electrical activation element, further comprises,
a second radiation-converting element electrically attached the latch circuit,
wherein radiation power transmitted to the first power converter permits power to flow from the source of power of the device to the device until a power off signal is transmitted to the device and
wherein radiation power transmitted to the second power converter turns off the gate signal to the triac to prevent the power from flowing from the source of power of the device to the device.

9. The remote activation system of claim 8 wherein the electrical device is a remotely activated device can be turned off with the same transmitted electromagnetic radiation.

10. The remote activation system of claim 1 wherein the switch, further comprises,
a triac element to permit alternating current to flow from the activation system toward the device,
a silicone controlled rectifier electrically attached to the radiation power converter and one connector from the power source of the device, and
a gate circuit that is electrically attached to the rectifier and the triac to allow current to flow from the rectifier to the triac and then allow power to flow from the source of power for the device to the device until a power off signal is transmitted to the device.

11. The remote activation system of claim 1 wherein the switch, comprises,
a first and second silicone controlled rectifier each electrically connected to the radiation power converter and to the power supply of the device to permit alternating current to flow toward the device and
a latch circuit that is electrically attached to the connector between the radiation converter and the silicon controlled rectifiers and to the connector from the power source to the device passing toward the device to allow alternating current to flow from the source of power for the device to the device until a power off signal is transmitted to the device.

12. The remote activation system of claim 1 wherein the electrical activation element, further comprises,
a second radiation power converter electrically attached to an electrically operated normally non-conducting switch and
a second electrically operated normally non-conducting switch that is between a source of power for the device and its on-off circuit, is electrically connected with the power converter, and has a non-conducting state such that the on-off circuit is not able to draw any power and a conducting state such that the on-off circuit is able to draw sufficient power for normal operation of the device,
wherein the first switch permits the electrical device to perform a first action when the first switch is conducting and the second switch permits the electrical device to perform a second action when the second switch is conducting.

13. The remote activation system of claim 11 wherein the electrical device is a remotely activated device with at least two actions that are initiated and maintained by the activation system such as a projector screen that is raised or lowered; a garage door that is raised or lowered; heating apparatus where heat is increased or decreased; blinds shades or awnings that are opened or closed; a ceiling fan that is set to summer or winter rotation; a window that is opened or closed.

14. The remote activation system of claim 1 wherein the electromagnetic radiation is from a group consisting of a high intensity infrared beam, a visible light beam, a radio beam, and a collimated light beam from a laser, and the intensity transmitted to the electrical activation element is high enough to prevent unintentional activation of the device from ambient radiation and is low enough to not cause safety concerns in the use contemplated.

15. The remote activation system of claim 1 wherein the electromagnetic radiation is from a group consisting of a high intensity infrared beam, a visible light beam, and a collimated light beam from a laser, and the intensity transmitted to the electrical activation element is high enough to prevent unintentional activation of the device from ambient radiation and is low enough to not cause safety concerns in the use contemplated.
